(19) United States
(12) Patent Application Publication
(10) Pub. No.: US 2009/0097741 A1
(43) Pub. Date: Apr. 16, 2009

(54) SMOTE ALGORITHM WITH LOCALLY LINEAR EMBEDDING

(76) Inventors: Mantao Xu, Shanghai (CN); JuanJuan Wang, Shanghai (CN)

Correspondence Address: Carestream Health, Inc., 150 Verona Street, Rochester, NY, 14608, US

(21) Appl. No.: 12/279,059

(22) PCT Filed: Mar. 30, 2006
(86) PCT No.: PCT/CN2006/000565

§ 371 Date: Aug. 12, 2008

(51) Int. Cl. G06K 9/62

(52) U.S. Cl. 382/159

(57) ABSTRACT

A data classification method. The method includes: providing data mapped in a first space; mapping the data into a second space using locally linear embedding to generate mapped data; applying a synthetic minority over-sampling technique (SMOTE) to the mapped data to generate new data; and mapping the new data into the first space.

### FIELD OF THE INVENTION

The invention relates generally to the field of digital medical image processing, and in particular to computer-aided-detection. More specifically, the invention relates to applying synthetic minority over-sampling technique for computer-aided-detection (CAD),

### BACKGROUND OF THE INVENTION

Computer aided detection (CAD) systems have been employed in the medical field, for example, for mammography to aid in the detection of breast cancer. The Kodak Mammography CAD System is an example of such a system. U.S. Patent Application Publication No. 2004/0024292 (Menhardt) relates to a system and method for assigning a computer aided detection application to a digital image.

A medical CAD system automatically identifies candidates for an object of interest in an image given known characteristics such as the shape of an abnormality (e.g., a polyp, mass, spiculation), extract features for each candidate, classifies candidates, and displays candidates to a radiologist for diagnosis. The classification is performed by a classifier that has been trained off-line from a training dataset, and then used in the CAD system. The training dataset is a database of images where candidates have been labeled by an expert. See for example US Patent Application Publication No. 2005/0010445 (Krishnan) and US Patent Application Publication No.2005/0281457 (Dundar).

The classification of imbalanced data is a common practice in the context of medical image intelligence. For example, imbalanced data classification often arises in practical applications in the context of medical pattern recognition and data mining. Many existing state-of-art classification approaches are developed by assuming the underlying training set is evenly distributed. However, a difficulty is that the highly skewed class distribution can lead to a severe bias of the resulting classifiers obtained by some state-of-art classification algorithms. That is, there can be a severe biasity problem when the training set is a highly imbalanced distribution (i.e., the data comprises of two classes, the minority class C₊ and the majority class C₋ ). Namely, the resulting decision boundary is severely biased to the minority class, and can lead to a poor performance according to the ROC curve analysis (Receiver Operator Characteristic Analysis). For this purpose, many classification algorithms have been investigated, such as the under-sampling technique over the majority class, the over-sampling technique over the minority class, the cost-sensitive learning algorithm, and feature selection.

Accordingly, there exists a need to address classification of imbalanced data.

### SUMMARY OF THE INVENTION

An object of the present invention is to provide a method for the classification of data, particularly imbalanced data.

Any objects provided are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a data classification method. The steps of the method include: providing data mapped in a first space; mapping the data into a second space using locally linear embedding to generate mapped data; applying a synthetic minority over-sampling technique (SMOTE) to the mapped data to generate new data; and mapping the new data into the first space.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows an illustration regarding the creation of synthetic data points in the SMOTE algorithm.

FIG. 2 shows an exemplary Pseudo-Code of the LLE-based SMOTE algorithm in accordance with the present invention.

FIG. 3 presents a description of three datasets from chest x-ray images databases.

FIG. 4 illustrates the classification results obtained by using three classifiers over the three datasets of FIG. 3.

FIG. 5 shows the areas of resulting ROC curves for the three datasets of FIG. 3.

### DETAILED DESCRIPTION OF THE INVENTION

The following is a detailed description of the preferred embodiments of the invention, reference being made to the drawings in which the same reference numerals identify the same elements of structure in each of the several figures.

Synthetic minority over-sampling technique (SMOTE) is a know approach to addressing the operational problem. Applicants enhance a conventional SMOTE algorithm by incorporating the locally linear embedding algorithm (LLE). That is, the LLE algorithm is first applied to map the high-dimensional data into a low dimensional space, where the input data is more separable, and thus can be over-sampled by SMOTE. Then the synthetic data points generated by SMOTE are mapped back to the original input space as well through the LLE, Experimental results demonstrate that the underlying approach attains a performance improved to that of a traditional SMOTE.

SMOTE (Synthetic Minority Over-sampling Technique) is an approach by over-sampling the positive class or the minority class. However, it is limited to a strict assumption that the local space between any two positive instances is positive or belongs to the minority class, which may not be always true in the case when the training data is not linearly separable. Applicants note that mapping the training data into a more linearly separable space, where the SMOTE algorithm can be conducted, can circumvent this limitation. However, if the positive class is oversampled synthetically in the linearly separable space, the newly generated data should be transformed back into the original input space. The transformation mapping from input data space into the linearly separable space should be feasibly invertible in practice. For this purpose, the Locally Linear Embedding (LLE) is employed for mapping from the original input space to the linearly separable space.

Applicants present an oversampling technique based on SMOTE and LLE. Generally, the training data is first mapped into a lower-dimensional space by LLE, where data is more separable. Then the SMOTE is applied to generate a desirable number of synthetic data points for the positive class. After which, these new data points are mapped back to the original input space.

The method is more particularly described below. The LLE algorithm is described, then the LLE-based SMOTE algorithm is described. A performance comparison result of the LLE based SMOTE algorithm and the conventional SMOTE algorithm are also described.

A Locally Linear Embedding (LLE) algorithm is now described.

The features extracted from medical images are often with a high dimensionality, and thus can result in an intractable geometry complexity in data classification. Moreover, they are non-linearly separable in Euclidean space. The pioneer solution is a class of manifold learning algorithms. Locally Linear Embedding, can reduce the high dimensionality by mapping the input data onto a low-dimensional manifold, where data become more separable.

For a give dataset X={x₁,x₂, . . . ,x_{N}} in a d-dimensional space R^{d}, the LLE algorithm is to seek a 1-dimensional dataset Y in R^{t}, which has the same local geometry structure in its k-Nearest-Neighbor graph (kNN) as X does. In other words, any point xεX is mapped to a point y=F(x)εY, such that, if x is linearly spanned by its k nearest neighbors X_{kNN}{xⱼ|1≦j ≦k}

$$\begin{matrix}x = {\sum }_{j = 1}^{k} {w}_{j} {x}_{j} then & ( 1 ) \\ y = {\sum }_{j = 1}^{k} {w}_{j} {y}_{j} & ( 2 )\end{matrix}$$

where w=(w₁, . . . ,wₖ) represents the coefficients of linear combination and yⱼ=F(xⱼ).

In practice, the LLE algorithm can be implemented in three steps: construct k-Nearest-Neighbor graph for X, estimate a weight matrix W for X, and extract the low-dimensional data Y, which are described as follows.

(1) Construct a k-Nearest-Neighbor graph G_{kNN}(X) for X: for each XⱼεX, its k nearest neighbors is represented as X_{kNN}(xᵢ)={xᵣ_{ᵥ}|1≦j≦k}.

(2) Estimates the weight matrix W such that xᵢ is best linearly spanned by X_{kNN}(xᵢ) as:

$$W = {arg min}_{W} {\sum }_{i = 1}^{N} {‖ x - {\sum }_{j = 1}^{k} {W}_{i {Γ}_{ij}} {x}_{{Γ}_{ij}} ‖}^{2} \qquad ( 3 )$$

where, for any i,j, and j≠Γᵢⱼ, Wᵢⱼ=0 and

$${\sum }_{j = 1}^{k} {W}_{i {Γ}_{ij}} = 1 \qquad ( 4 )$$

(3) Extract the embedding data Y by minimization of:

$$\begin{matrix}ɛ ( Y ) = {\sum }_{j = 1}^{k} {‖ {y}_{i} - {W}_{ij} y ‖}^{2} \\ = {\sum }_{i = 1}^{N} {\sum }_{j = 1}^{N} {M}_{ij} {y}_{i}^{T} {y}_{i}\end{matrix} \qquad ( 5 )$$

where M=(I−W)^{T}(I−W) and W can be represented through sparse matrices. The eigenvectors of M corresponding to the smallest nonzero eigenvalues are the resulting embedding data Y.

A LLE-based SMOTE algorithm is now described.

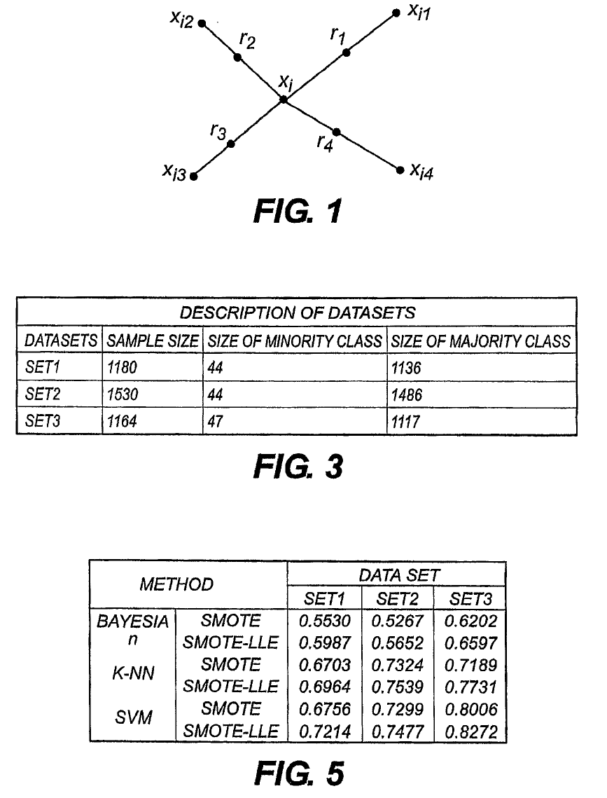

A typical practice in the classification of imbalanced data source is to oversample the minority class. In the Synthetic Minority Over-sampling Technique (SMOTE), the minority class is over-sampled by using k-Nearest-Neighbor graph instead of randomized sampling with replacement. Motivated by its application in handwritten character recognition, SMOTE has received an interest in the pattern recognition community. Applicants denote the desirable number of synthetic data points created by SMOTE as m. The SMOTE algorithm oversamples the minority class C₊, by using its kNN graph. Firstly, for each of vector x in C₊, ml|C₊| number of end points are randomly chosen from its k-nearest positive neighbors (i.e., the k-nearest neighbors in C₊). And then the synthetic data points are created through a randomized interpolation between x and the ml|C₊| number of end points selected in X_{kNN}(x) respectively, which is demonstrated in FIG. 1. More particularly, FIG. 1 shows an illustration on how to create the synthetic data points in the SMOTE algorithm.

However, the randomized interpolation can incur an additive noise for the original input data or violate the inherent geometrical structure of minority class and majority class, whereby the evaluation of the resulting classifiers becomes quite difficult. Instead of using the randomized interpolation scheme above, for each x, Applicants generate new synthetic data points by seeking the vector r on each line segment from x to each xⱼ in X_{kNN}(X) such that it has the maximum average distance from the majority class C₋ as in equation (6).

$$r = {arg max}_{r ∈ {\overline{xx}}_{j}} \frac{1}{k} {\sum }_{{x}_{-} ∈ {C}_{-}} ‖ r - {x}_{-} ‖ \qquad ( 6 )$$

This provides for a separation of synthetic data r from the majority class.

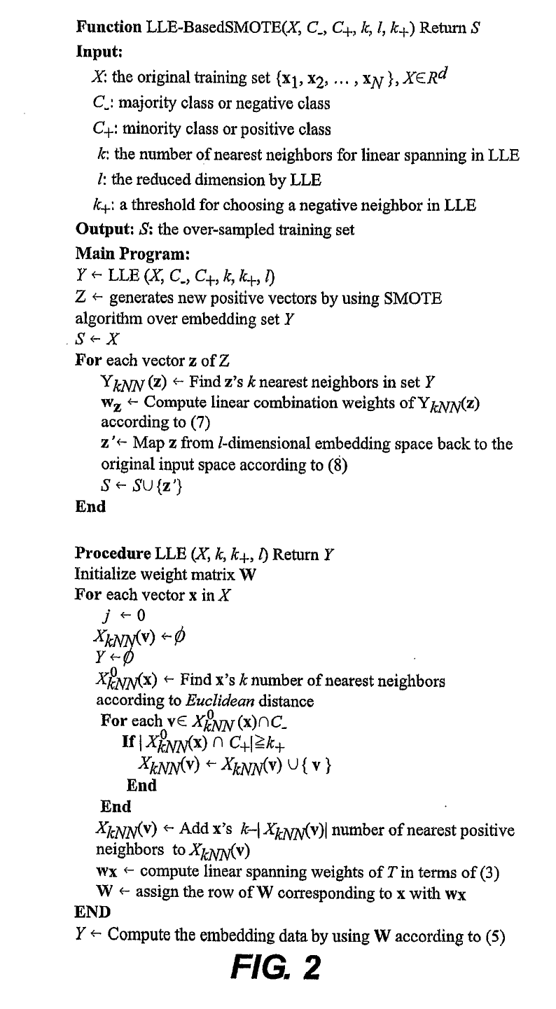

Even if the synthetic data can be interpolated deterministically according to equation (6), oversampling of minority class in the original input space is restricted by an assumption that the local space between any pair of positive data points is positive. But this strict assumption is not always true when the original data is not linearly separable. In order to relax this assumption, the LLE technique can be applied to mapping the original data into a new linearly separable feature space. Then, the SMOTE algorithm oversamples minority class in the new feature space instead. An advantage of LLE over the other state-of-art learning algorithms is that a new synthetic vector z generated in the new feature space can be mapped back to the original input space according to the equations:

$$\begin{matrix}w = {arg min}_{w} {\sum }_{i = 1}^{N} {‖ z - {\sum }_{j = 1}^{k} {w}_{j} {y}_{j} ( z ) ‖}^{2} and & ( 7 ) \\ {z}^{′} = {\sum }_{j = 1}^{k} {w}_{j} {x}_{j} ( z ) & ( 8 )\end{matrix}$$

where yⱼ(z) is z's k nearest neighbors in embedding set Y and xⱼ(z) is the corresponding vector of yⱼ(z) in the original input space. The application of LLE fulfills the strict assumption required by the oversampling techniques, whereby any classifiers can be designed in the original input space. The underlying LLE-based SMOTE algorithm is demonstrated in FIG. 2. More particularly, FIG. 2 shows a Pseudo-Code of the LLE-based SMOTE algorithm.

In contrast to the LLE algorithm described above, Applicants present an alternative method for selecting k nearest neighbor vectors, which participate the computation in equations (4) and (5). Namely, for each x in X, its nearest neighbors X_{kNN}(x), is constructed by incorporating the information of two classes for X, i.e., the minority class C₊ and the majority class C₋ where X=C₊∪C₋. Applicants first seek the k number of nearest neighbors for x, X⁰_{kNN}(x), according to Euclidean distance and set X_{kNN}(x) empty. If X⁰_{kNN}(x) is constructed for each x, for any negative vector v in X⁰_{kNN}(x), if the number of its positive neighbors in X_{kNN}(v) is greater than k₊, Applicants add v to X_{kNN}(x). Finally, since the size of X_{kNN}(x) is obviously less than k, the k-|X_{kNN}(x)| number of nearest positive neighbors of x are added to X_{kNN}(x). The implementation of this alternative LLE scheme is demonstrated in FIG. 2.

Experimental results are now described.

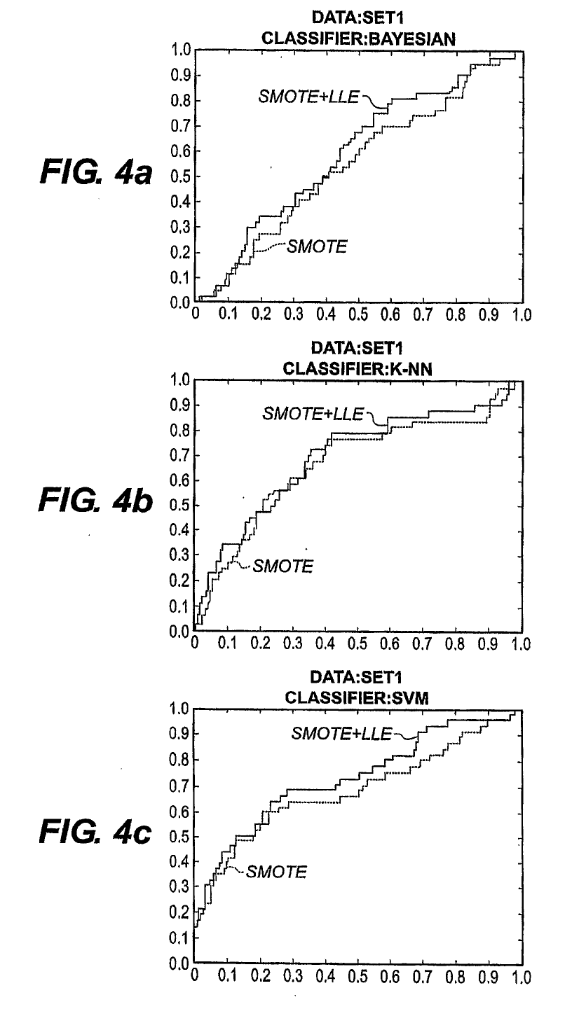

Applicants evaluated the proposed LLE-based SMOTE algorithm by conducting the leave-one-out validation tests on three datasets and applying three classifiers: Naive Bayesian Classifier, k-Nearest-Neighbor Classifier, and Support Vector Machine. As a comparison benchmark, the conventional SMOTE algorithm is also evaluated in the experimental test. The three datasets are collected from several chest x-ray image databases in automatic computerized detection of pulmonary. Each of data vectors is with 33 features extracted from a region of interest (ROI) that is located and segmented by a series of image enhancement and segmentation algorithms. The description of datasets is presented in FIG. 3.

The ROC curve (receiver operating characteristic) serves as a tool in evaluating classification performance obtained by using LLE-based SMOTE and SMOTE, which plots the true positive rate as a function of false positive. It is considered by some individuals in medical diagnosis that the larger the area below the resulting ROC curve is, the better the classification performance is attained.

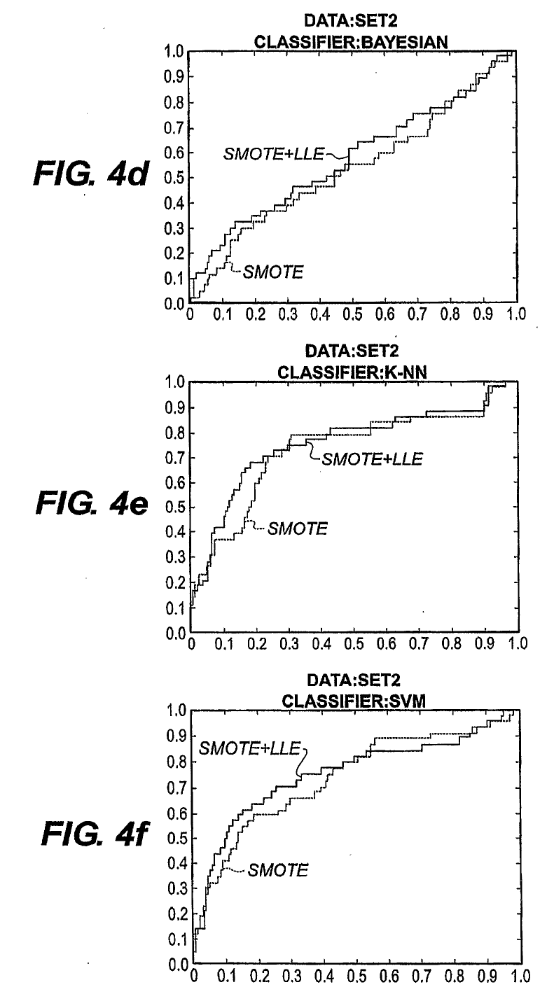

In the experiments, the minority class is only oversampled as two times large as its original size. The three parameters in FIG. 2 are defined as: k =33, l=7 and k₊=9. We report the classification results obtained by using the three classifiers over the three datasets respectively in FIG. 4. More particularly, FIG. 4 shows ROC curves obtained by the three classifiers: Naive Bayesian classifier, k Nearest Neighbor classifier (K-NN) and Support Vector Machine.

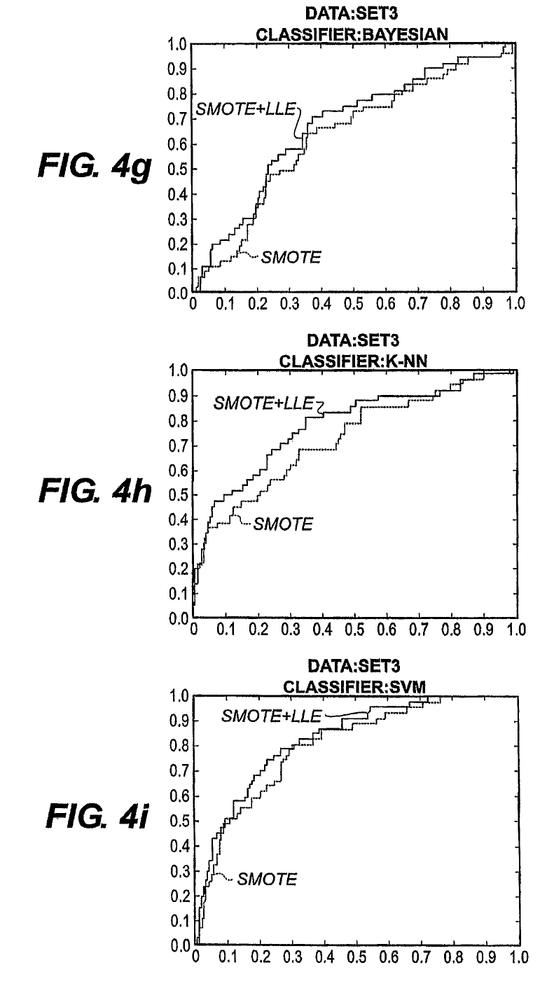

The areas of resulting ROC curves obtained are also reported in FIG. 5. More particularly, FIG. 5 shows areas of ROC curves obtained by the three classifiers by incorporating LLE-based SMOTE and SMOTE. It can be observed that the LLE-based SMOTE algorithm outperforms the conventional SMOTE algorithm for each of classifiers.

Thus data classification method described by Applicants includes the steps of: providing data mapped in a first space; mapping the data into a second space using locally linear embedding to generate mapped data; applying a synthetic minority over-sampling technique (SMOTE) to the mapped data to generate new data; and mapping the new data into the first space.

Accordingly, Applicants have described an oversampling technique, LLE-based SMOTE for the classification of imbalanced data. The underlying oversampling algorithm is implemented by incorporating the Locally Linear Embedding technique into the SMOTE algorithm. Experimental results demonstrate that the LLE-based SMOTE algorithm attains a performance enhanced to that of the conventional SMOTE.

References known to Applicants include:

Chawla, N., Bowyer, K., Hall, L. & Kegelmeyer, W, SMOTE: Synthetic Minority Over-sampling Technique. Journal of Artificial Intelligence Research, 2002, 16: 341-378;

Sam T R, Lawrence K. S. Nonlinear dimensionality reduction by locally linear embedding. Science, 2000, 290(5500): 2323-2326;

Xu Zhi-jie, Yang Jie & Wang Meng. A new nonlinear dimensionality reduction for color image. Journal of Shanghai Jiaotong University, 2005,39(2): 279-283;

Rehan Akbani, Stephen Kwek, & Nathalie Japkowicz. Applying Support Vector Machines to Imbalanced Datasets. ECML 2004: 39-50;

Zhan De-chuan, Zhou Zhi-hua. Neighbor Line-based Locally linear Embedding. Proceedings of the 10th Pacific-Asia Conference on Knowledge Discovery and Data Mining 2006;

Dick de Ridder, Marco Loog & Marcel J. T. Reinders. Local Fisher Embedding. ICPR 2004, 2: 295-298; and

Yi Sun, Mark Robinson, Rod Adams, Paul Kaye, Alistair G. Rust, & Neil Davey Using a Hybrid Adaboost Algorithm to Integrate Binding Site Predictions. ICMI 2005.

A preferred embodiment of the present invention is described as a software program. Those skilled in the art will recognize that the equivalent of such software may also be constructed in hardware. Because image manipulation algorithms and systems are well known, the present description will be directed in particular to algorithms and systems forming part of, or cooperating more directly with, the method in accordance with the present invention. Other aspects of such algorithms and systems, and hardware and/or software for producing and otherwise processing the image signals involved therewith, not specifically shown or described herein may be selected from such systems, algorithms, components and elements known in the art.

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

All documents, patents, journal articles and other materials cited in the present application are hereby incorporated by reference.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive.

1. A data classification method, comprising the steps of:
providing data mapped in a first space;
mapping the data into a second space using locally linear embedding to generate mapped data;
applying a synthetic minority over-sampling technique (SMOTE) to the mapped data to generate new data; and
mapping the new data into the first space.

2. The method of claim 1, wherein the second space is a lower-dimensional space than the first space.

3. The method of claim 1, wherein the second space is a linearly separable feature space.

4. A computer storage product having at least one computer storage medium having instructions stored therein causing one or more computers to perform the method of claim 1.
